(19) United States
(12) Patent Application Publication
(10) Pub. No.: US 2007/0210999 A1
(43) Pub. Date: Sep. 13, 2007

(54) Driving method for light emitting device

(75) Inventor: Jae Do Lee, Gumi-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/503,978

(22) Filed: Aug. 15, 2006

(30) Foreign Application Priority Data
Mar. 7, 2006 (KR) 10-2006-0021503

(51) Int. Cl. G09G 3/32

(52) U.S. Cl. 345/83

(57) ABSTRACT

A driving method for a light emitting device according to the present invention comprises inputting a scan signal to a pixel comprising two and more sub-pixels formed between data lines and scan lines through the scan lines; and inputting data signals to the two and more sub-pixels so that at least one of the data signals inputted through the data lines has the start point and end point different from at least one of the others.

This Nonprovisional application claims priority under 35 U.S.C. §119(a) on Patent Application No. 2006-21503 filed in Korea on Mar. 7, 2006 the entire contents of which are hereby incorporated by reference.

### BACKGROUND OF THE INVENTION

1. Field of the Invention

The present invention relates to a driving method for a light emitting device.

2. Description of the Related Art

A light emitting device used for a light emitting display was a self light emitting device in which a light emitting layer is formed between two electrodes. The light emitting device could be classified into an inorganic light emitting device and an organic light emitting device according to the material which it is made of. In addition, the light emitting device was classified into a passive matrix type and an active matrix type according to the driving method of its light emitting layer.

FIG. 1 is a sectional view of a conventional organic light emitting device.

In the conventional organic light emitting device 100 as shown, on a substrate 10 is formed an anode electrode 20 which is made of a transparent material, and on the anode electrode 20 are deposited a hole injection layer and hole transport layer 30, a light emitting layer 40 which is made of an organic material, an electron injection layer and electron transport layer 50, and a cathode electrode 60 which is made of a metal having a low work function.

This organic light emitting device 100 has been suffered from difficulty in expressing equal gray levels due to problems such as interference between neighboring pixels and cross-talk generated by data or scan signals applied on the anode electrode 20 and cathode electrode 60.

FIG. 2 is a timing driving diagram in which data signals are synchronized with the start point of a scan signal, and FIG. 3 is a timing driving diagram in which data signals are synchronized with the end point of a scan signal.

In this driving method of the conventional organic light emitting device, data signals R, G, B inputted to R, G, B sub-pixels during one scan area (t) concentrated their loads on the start point or end point of the scan signal Scan [n], creating brightness deviation, as shown in FIGS. 2 and 3.

This resulted from cross-talks in which the start points A or end points B of the data signals R, G, B inputted to each R, G, B sub-pixel are all equally inputted and voltage difference applied to the cathode electrode placed in a specific area is formed differently.

This problem incurred brightness deviation between neighboring pixels and created image blur upon displaying images, thus causing the deterioration of image displaying quality.

### SUMMARY OF THE INVENTION

Accordingly, an object of the present invention is to solve at least the problems and disadvantages of the background art.

A driving method for a light emitting device according to the present invention comprises inputting a scan signal to a pixel comprising two and more sub-pixels formed between data lines and scan lines through the scan lines; and inputting the data signals so that at least one of the data signals inputted through the data lines has the start point and end point different from at least one of the others.

The pixel comprises three and more R, G, B sub-pixels, and the data signals, respectively, may have the different location of the start point in inputting the data signals.

The pixel comprises three and more R, G, B sub-pixels, and the data signals, respectively, may have the different location of the end point in inputting the data signals.

The pixel comprises three and more R, G, B sub-pixels, and the data signals may have middle points interiorly dividing the data signals, which are not overlapped with one another in inputting the data signals.

The pixel comprises three and more R, G, B sub-pixels, and any one of the data signals inputted to the R, G, B sub-pixels may be varied in its signal width with respect to the start point of the corresponding data signal inputted according to each scan signal.

The pixel comprises three and more R, G, B sub-pixels, and another of the data signals inputted to the R, G, B sub-pixels may be varied in its signal width with respect to the end point of the corresponding data signal inputted according to each scan signal.

The pixel comprises three and more R, G, B sub-pixels, and the other of the data signals inputted to the R, G, B sub-pixels may be varied so that the left half and right half signal widths are equal with respect to the middle point between the start point and end point of the corresponding data signal inputted according to each scan signal.

The pixel comprises three and more R, G, B sub-pixels, and assuming the magnitude of scan signal is 100%, the data signals inputted to R, G, B sub-pixels may be modulated and inputted by the magnitude of ⅓ of the scan signal.

The scan signal inputted in inputting the scan signal and the first data signal inputted in inputting the data singnals may be equal in the location of the start point.

The pixel comprises three and more R, G, B sub-pixels, and each of the data signals inputted to R, G, B sub-pixels may be synchronized with the start point, end point, and middle point of the scan signal to be inputted to the sub-pixels.

The pixel comprises three and more R, G, B sub-pixels, and each of the data signals inputted to R, G, B sub-pixels may be inputted while leaving a time difference as much as ±Δt from the start point and end point of the scan signal.

Inputting the data signals further comprises inputting pre-charges for inputting a preliminary charging current to the data line, and the data signals may be inputted concurrently or posterior to the start point when the preliminary charging current is inputted.

The start point of signals inputted in inputting the scan signal and inputting the data signals may be located after a point when the signal level rises or a point when the signal level rises and then reaches the peak level, and the end point of signals inputted in inputting the scan signal and inputting the data signals may be located after a point when the signal level falls down or a point when the signal level falls down and then becomes a lower level.

### BRIEF DESCRIPTION OF THE DRAWINGS

The invention will be described in detail with reference to the following drawings in which like numerals refer to like elements.

FIG. 1 is a sectional view of a conventional organic light emitting device.

FIG. 2 is a timing driving diagram in which data signals are synchronized with the start point of a scan signal.

FIG. 3 is a timing driving diagram in which data signals are synchronized with the end point of a scan signal.

FIG. 4 is a pixel circuit diagram of an organic light emitting device.

FIG. 5 is a timing driving diagram of a light emitting device according to an embodiment of the present invention.

FIG. 6 is a timing driving diagram of a light emitting device according to a variation to the embodiment.

FIG. 7 is a timing driving diagram of a light emitting device according to a variation to the embodiment.

FIG. 8 is a timing driving diagram of a light emitting device according to a variation to the embodiment.

FIG. 9 is a timing driving diagram of a light emitting device according to a variation to the embodiment.

FIG. 10 is a timing driving diagram of a light emitting device according to a variation to the embodiment.

FIG. 11 is a view of illustrating a signal inputted to a light emitting device.

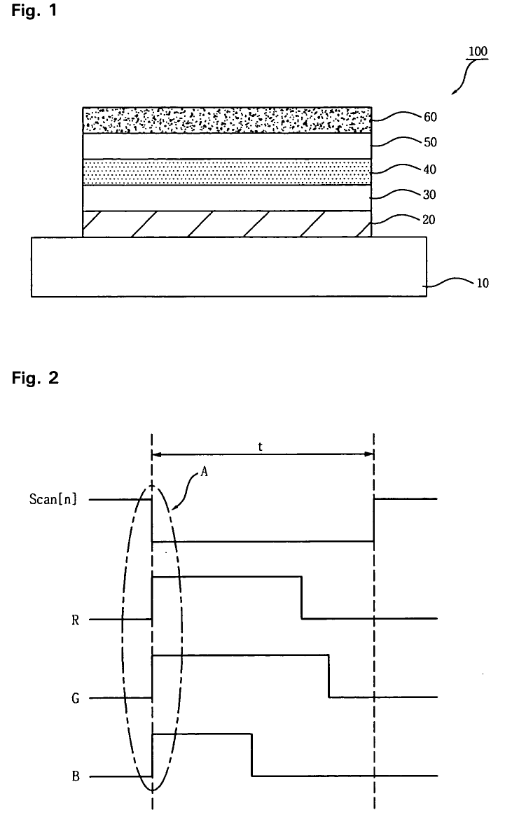

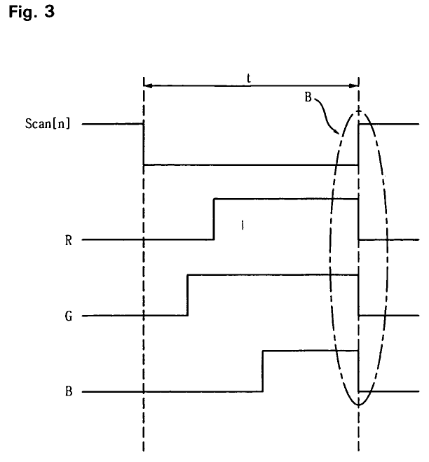

### DETAILED DESCRIPTION OF PREFERRED EMBODIMENTS

Preferred embodiments of the present invention will be described in a more detailed manner with reference to the drawings.

### First Embodiment

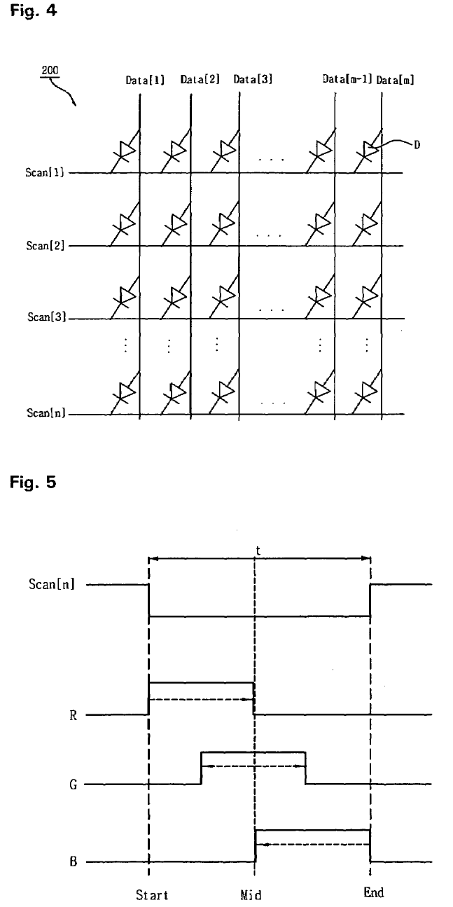

FIG. 4 is a pixel circuit diagram of a light emitting device.

In a pixel circuit 200 of the light emitting device, light emitting parts D are formed in the intersection regions of multiple data lines Data[1] to Data[m] and multiple scan lines Scan[1] to Scan[n] intersecting one another as shown in FIG. 4.

In the light emitting device, a sub pixel (not shown) is formed on the substrate, which consists of a first electrode, light emitting part, and a second electrode, and a plurality of sub pixel groups form a pixel part for displaying. The pixel parts formed on the substrate are sealed by a protection substrate and protected from moisture or oxygen. A light emitting layer of the light emitting part may be formed of an organic material or an inorganic material, and it may be arranged in the back surface light emitting type, front surface light emitting type, and both surface light emitting type, based on the light emitting direction.

The data line and scan line electrically connected to the first electrode and second electrode may be supplied with data signals and scan signals from the driving device, and a driving method of supplying data signals and scan signals may be equal to that of the embodiments of the present invention.

A driving method of a light emitting device according to an embodiment of the present invention comprises inputting a scan signal and inputting data signals. Inputting the data signals may further include inputting pre-charges which are to pre-charge preliminary charging current values in accordance with data gray levels.

The embodiment describes a case where data signals are pulse width modulated and inputted to the data line so that one and more of their start points, middle points, and end points are not overlapped.

In inputting scan signals, a scan signal is inputted through scan lines to a pixel comprising two and more sub-pixels formed between the data lines and scan lines.

FIG. 5 is a timing driving diagram of a light emitting device according to the first embodiment of the present invention.

Referring to FIG. 5, the scan signal Scan[n] inputted through inputting the scan signals becomes a scan signal Scan[n] which corresponds to one scan area (t).

In inputting data signals, data signals are inputted to two and more sub-pixels such that at least one of data signals inputted through the data lines has different start point and end point from at least one of the others.

The sub-pixels constituting one pixel may be configured to implement images with two colors, the smallest unit of colors, but data signals may be inputted to the sub-pixels comprising three colors such as R, G, B or four colors such as R, G, B, W in which white color is added to the three colors.

Accordingly, in a case where the sub-pixel consists of two colors, at least one of the data signals may be inputted to the sub-pixel with its start point and end point both being different from at least one of the others.

Referring to FIG. 5, which illustrates an example where the pixel consists of R, G, B sub-pixels, the data signals R, G, B inputted through inputting data signals may be as follows.

The data signals R, G, B inputted through inputting data signals are all different from one another in their start points inputted through the data line.

Here, of the data signals R, G, B inputted to the R, G, B sub-pixels, the data signal R inputted to the R sub-pixel may be inputted so that its signal width increases or decreases variably with respect of the start point of the inputted signal.

In addition, the data signal B inputted to the B sub-pixel may be inputted so that its signal width increases or decreases variably with respect to the end point of the inputted signal.

Moreover, the data signal G inputted to the G sub-pixel may be inputted so that its signal width increases or decreases variably, with the left and right signal widths being equal with respect to the middle point, an interior division point of the start point and end point of the inputted signal.

Here, the signal width of the data signals R, G, B inputted to the R, G, B sub-pixels may be varied with respect to the start point or end point of the corresponding data signals inputted according to each scan signal, and may be varied so that the left half and right half signal widths are equal with respect to the middle point of the start point and end point.

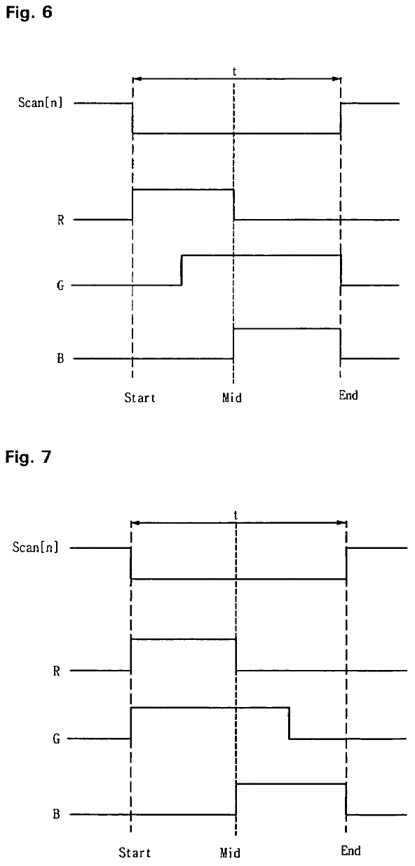

FIG. 6 is a timing driving diagram of a light emitting device according to a variation to the embodiment.

A variation to the embodiment will be described with reference to FIG. 6, wherein the start points of the data signals R, B inputted through inputting data signals are all different, however, the data signal G, at least any one of the data signals, is placed between the start point and end point, and its end point may be the same as that of the data signal B.

FIG. 7 is a timing driving diagram of a light emitting device according to a variation to the embodiment.

Another variation to the embodiment will be described with reference to FIG. 7, wherein the end points of the data signals R, B inputted through inputting data signals are all different, however, the data signal G, at least any one of the data signals, may have the same start point as that of the data signal R.

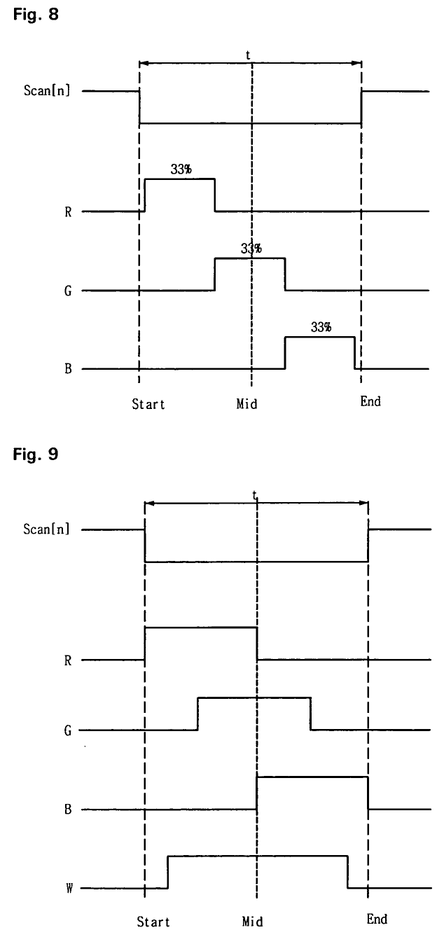

FIG. 8 is a timing driving diagram of a light emitting device according to a variation to the embodiment.

Still another variation to the embodiment will be described with reference to FIG. 8, wherein the data signals R, G, B inputted through inputting data signals all may be inputted without any overlapping areas. This means that assuming the magnitude of scan signal is 100%, the data signals inputted to R, G, B sub-pixels may be modulated and inputted by the magnitude of ⅓ of the scan signal.

This method enables the light emitting device to generate a constant light all the time when the light emitting device is employed as an illumination device or light source.

FIG. 9 is a timing driving diagram of a light emitting device according to a variation to the embodiment.

Still another variation to the embodiment will be described with reference to FIG. 9, which illustrates as an example a case where a pixel consists of R, G, B, W sub-pixels, wherein the data signals R, G, B, W inputted through inputting data signals all may have the different start points and end points.

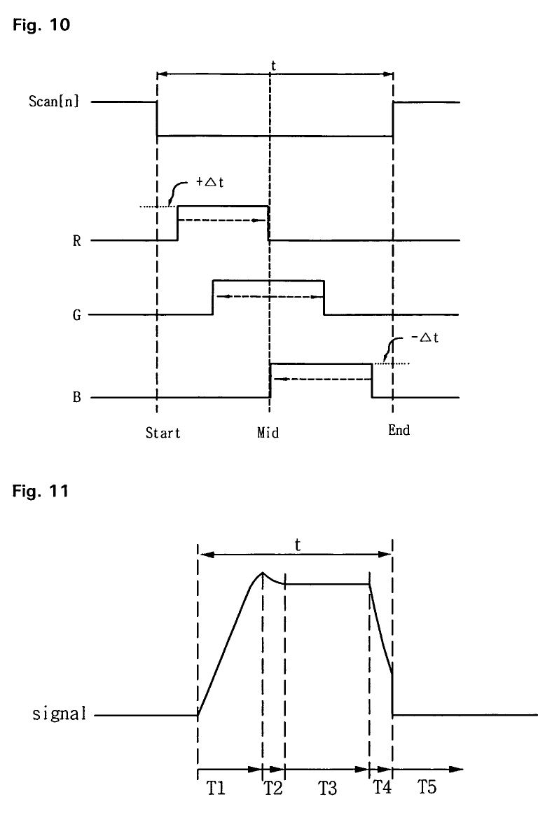

FIG. 10 is a timing driving diagram of a light emitting device according to a variation to the embodiment.

Referring to FIG. 10, the data signals R, G, B may be inputted while leaving a time difference as much as ±Δt between their start points or end points. This may be to input the data signals after sufficient pre-charging is accomplished in a case where a lot of loads are applied to the data lines, and this driving method may cause the light emitting start point or end point of the sub-pixels to be different. The light emitting start point and end point may be sensed by human eyes, and the sub-pixels may be light-emitted when the values of the scan signal and data signal satisfy the requirements for light emitting. On the other hand, the scan signal as well as the data signals may be inputted while leaving a time difference as much as ±Δt. And, the data signals and scan signal may be synchronized with one another to be inputted.

FIG. 11 is a view of illustrating a signal inputted to a light emitting device.

Referring to FIG. 11, the start point of signals inputted in inputting the scan signal and inputting the data signals may be located after a point T1 when the signal level rises or a point T3 when the signal level reaches the peak level. The point when the signal level reaches the peak level may be a point T2 occasionally. And, the end point of signals inputted in inputting the scan signal and inputting the data signals may be located after a point T4 when the signal level falls down or a point T5 when the signal level falls down and then becomes a lower level.

Although the data signals R, G, B are indicated in the drawings and described assuming the data signals are R, G, B signals in the afore-mentioned embodiments, it should be understood that this is for the convenience of description. It should also be understood that the data signals R, G, B may be inputted concurrently or posterior to the start point when the preliminary charging current is inputted.

The driving method may not only reduce the width of the data signals in order to input a high brightness of data signals during a short scan time but also compensate the reduced width with height.

The above described embodiments may modulate all the data signals R, G, B so that the data signals are not overlapped to one another, reduce the load of data signals applied to the data line, and prevent cross-talks from being generated by brightness difference between the same gray levels, thus improving the quality of display. In addition, the first embodiment may provide an effect of being capable of reducing consumption power since currents applied to each sub-pixel are not driven at the same time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A driving method for a light emitting device comprising:
inputting a scan signal to a pixel comprising two and more sub-pixels formed between data lines and scan lines through the scan lines; and
inputting the data signals so that at least one of the data signals inputted through the data lines has the start point and end point different from at least one of the others.

2. The driving method for the light emitting device of claim 1, wherein
the pixel comprises three and more R, G, B sub-pixels, and
the data signals, respectively, have the different location of the start point in inputting the data signals.

3. The driving method for the light emitting device of claim 1, wherein
the pixel comprises three and more R, G, B sub-pixels, and
the data signals, respectively, have the different location of the end point in inputting the data signals.

4. The driving method for the light emitting device of claim 1, wherein
the pixel comprises three and more R, G, B sub-pixels, and
the data signals have middle points which are not overlapped with one another in inputting the data signals, the middle points interiorly dividing the data signals.

5. The driving method for the light emitting device of claim 1, wherein
the pixel comprises three and more R, G, B sub-pixels, and
any one of the data signals inputted to the R, G, B sub-pixels is varied in its signal width with respect to the start point of the corresponding data signal inputted according to each scan signal.

6. The driving method for the light emitting device of claim 1, wherein
the pixel comprises three and more R, G, B sub-pixels, and
another of the data signals inputted to the R, G, B sub-pixels is varied in its signal width with respect to the end point of the corresponding data signal inputted according to each scan signal.

7. The driving method for the light emitting device of claim 1, wherein
the pixel comprises three and more R, G, B sub-pixels, and
the other of the data signals inputted to the R, G, B sub-pixels is varied so that the left half and right half signal widths are equal with respect to the middle point between the start point and end point of the corresponding data signal inputted according to each scan signal.

8. The driving method for the light emitting device of claim 1, wherein
the pixel comprises three and more R, G, B sub-pixels, and
assuming the magnitude of scan signal is 100%, the data signals inputted to R, G, B sub-pixels may be modulated and inputted by the magnitude of ⅓ of the scan signal.

9. The driving method for the light emitting device of claim 1, wherein
the scan signal inputted in inputting the scan signal and the first data signal inputted in inputting the data singnals are equal in the location of the start point.

10. The driving method for the light emitting device of claim 1, wherein
the pixel comprises three and more R, G, B sub-pixels, and
each of the data signals inputted to R, G, B sub-pixels is synchronized with the start point, end point, and middle point of the scan signal to be inputted to the sub-pixels.

11. The driving method for the light emitting device of claim 1, wherein
the pixel comprises three and more R, G, B sub-pixels, and
each of the data signals inputted to R, G, B sub-pixels are inputted while leaving a time difference as much as ±Δt from the start point and end point of the scan signal.

12. The driving method for the light emitting device of claim 1, wherein
inputting the data signals further comprises inputting pre-charges for inputting a preliminary charging current to the data line, and
the data signals are inputted concurrently or posterior to the start point when the preliminary charging current is inputted.

13. The driving method for the light emitting device of claim 1, wherein
the start point of signals inputted in inputting the scan signal and inputting the data signals is located after a point when the signal level rises or a point when the signal level rises and then reaches the peak level, and
the end point of signals inputted in inputting the scan signal and inputting the data signals is located after a point when the signal level falls down or a point when the signal level falls down and then becomes a lower level.

14. The driving method for the light emitting device of claim 1, wherein
the sub-pixel comprises an organic light emitting layer.
